(19) United States
(12) Patent Application Publication
(10) Pub. No.: US 2015/0321105 A1
(43) Pub. Date: Nov. 12, 2015

(54) ROSTER MANAGEMENT SYSTEM, METHOD AND APPARATUS

(71) Applicants: Eric Kyle ANDERSON, Freeland, MD (US); Thomas John KEMPISTY, Scotch Plains, NJ (US)

(72) Inventors: Eric Kyle ANDERSON, Freeland, MD (US); Thomas John KEMPISTY, Scotch Plains, NJ (US)

(21) Appl. No.: 14/548,926

(22) Filed: Nov. 20, 2014

Related U.S. Application Data
(60) Provisional application No. 61/990,332, filed on May 8, 2014.

(51) Int. Cl. A63F 13/828

(52) U.S. Cl. CPC A63F 13/828

(57) ABSTRACT

A method comprises generating a user profile in a roster management system. The user profile is associated with at least one team of a plurality of teams that together form a league. A player draft associated with the league is monitored. At least some of the teams have an assigned draft position within at least one round of the player draft, the assigned draft position being used by a corresponding team to select a player from a list of available players. The list of available players is updated based on the selection of a player. A team-selected player chosen in the draft position assigned to the at least one team associated with the user profile is identified. A user-selected player chosen from the list of available players in the assigned draft position that corresponds to the at least one team associated with the user profile is stored in a database.

### RELATED APPLICATIONS

The present application is based on, and claims priority from, Provisional Application No. 61/990,332, filed May 8, 2014, the disclosure of which is hereby incorporated by reference herein in its entirety.

### BACKGROUND

Some sports leagues conduct a draft process by which teams that are included in a particular league obtain rights to one or more players that are eligible to be selected from a player pool. Many player drafts include multiple rounds in which each team in the league is supposed to have a draft pick. In some cases, however, a team may have more than one pick in a particular round, or no picks at all. For example, draft picks are sometimes traded or interchanged, compensatory picks are sometimes awarded, and/or picks are sometimes taken away as a penalty for misbehavior.

Many leagues hold an annual draft, but some leagues hold additional drafts throughout the year such as a supplemental draft or expansion draft. With so few opportunities to obtain exclusive rights to an eligible player, there is a great deal of importance placed on a team's ability to draft quality players. Drafted players often serve as a nucleus for the future success of that particular team. Because a team's success is often determined based on how well that particular team drafts players, player drafts are often high profile events that involve sports, broadcasting, entertainment, and news businesses and personalities. Commentators and fans often provide insight and opinions with respect to the selection and/or potential selections by teams, which of course provides many opportunities to second guess one or more of a team's player selections during and after a league draft for years to come.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a roster management system, in accordance with one or more embodiments.

FIG. 2 is a flowchart of a method of amassing and assessing a user-selected roster, in accordance with one or more embodiments.

FIG. 3 is a diagram of a user interface used to rank a list of available players, in accordance with one or more embodiments.

FIG. 4 is a diagram of a user interface used to identify a team to be associated with a user profile, in accordance with one or more embodiments.

FIG. 5 is a diagram of a user interface used to select a player from a list of available players, in accordance with one or more embodiments.

FIG. 6 is a diagram of user interface used in a post-draft simulation, in accordance with one or more embodiments.

FIG. 7 is a diagram of a chip set by which an embodiment is implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. The present disclosure may repeat reference numerals and/or letters in the various examples. This repetition is for the purpose of simplicity and clarity and does not in itself dictate a relationship between the various embodiments and/or configurations discussed.

Sports fans and commentators often second guess one or more of a team's player selections during and/or after a league's player draft. Fans and commentators often assert that they would have selected a different player if given the opportunity to step into the shoes of a team owner, general manager, coach, director of player personnel, or other suitable person-in-charge. Many sports fans dream of an opportunity to show that they could draft better than the professionals, but do not have a way to provide proof.

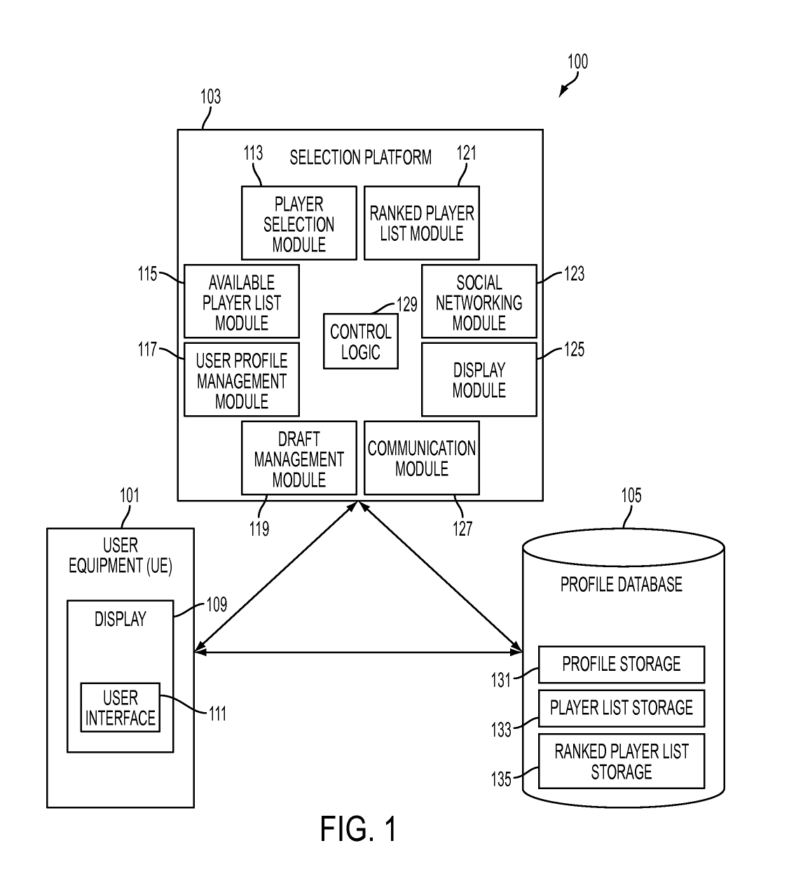

FIG. 1 is a diagram of a roster management system 100, in accordance with one or more embodiments. In some embodiments, the roster management system 100 makes it possible for a user to select one or more players during or after a player draft from a list of players available at a moment in time that a particular team is set to make the team's player selection in an assigned draft position, amass a list of user-selected players, and/or compare the list of user-selected players to a list of team-selected players.

In some embodiments, a player draft refers to a draft process by which players are selected by teams to compete on a professional level. For example, some professional sports leagues draft players from a player pool that comprises non-professional or amateur athletes such as college athletes, high school athletes, or athletes that have otherwise not previously played on a professional level to join the selecting team as a member of that team, at least temporarily, in the future. In some embodiments, a player pool optionally comprises at least some athletes that have previously played on a professional level, in the drafting sport or an other sport, for example, and are otherwise not currently on a team's player roster, or are left unprotected by a team that is a member of the league holding the player draft thereby making the unprotected player eligible for drafting by another team. In some embodiments, the player draft refers to a draft process by which players are selected by teams to compete on an amateur or semi-professional level.

In some embodiments, the player pool, or list of eligible players is a fixed list of available players that is capable of being updated to indicate a player is unavailable based on the player being selected by a team or user in the player draft. In other embodiments, the player pool or list of eligible players is an infinite list of available players that is capable of being updated to indicate a player is unavailable based on the player being selected by a team or user in the player draft. For example, in some embodiments, a default list of available players that includes players eligible to be drafted is capable of being edited or altered to include one or more players that are left-off of the default list of available players, but are otherwise known to a user of the roster management system 100.

As shown in FIG. 1, the roster management system 100 comprises a user equipment (UE) 101, having connectivity to a selection platform 103, and a profile database 105.

The UE 101 is a type of mobile terminal, fixed terminal, or portable terminal including a desktop computer, laptop computer, notebook computer, netbook computer, tablet computer, wearable circuitry, mobile handset, or combination thereof. The UE 101 comprises a display 109 by which a user interface 111 is displayed. In some embodiments, the user interface 111 is additionally or alternatively an audio interface or an interface that interacts with a user via a haptic response. A user interacts with the selection platform 103 using user interface 111 to select one or more players and populate a draft roster comprising one or more players selected during a player draft.

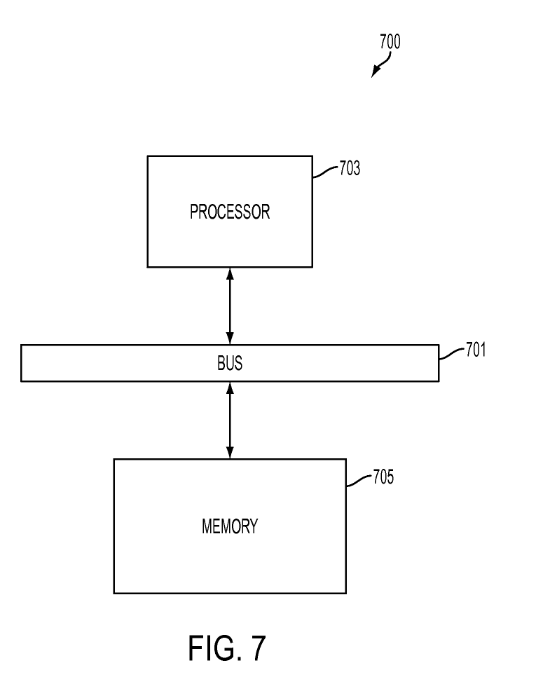

Selection platform 103 is a set of computer readable instructions that, when executed by a processor such as a processor 703 (FIG. 7), facilitates selecting a player from a list of available players, updating the list of available players, and storing one or more user-selected players in database 105. The selection platform 103 comprises a plurality of computing modules including a player selection module 113, an available player list module 115, a user profile management module 117, a draft management module 119, a ranked player list module 121, a social networking module 123, a display module 125, a communication module 127 by which the selection platform 103 communicates with the UE 101 and the profile database 105, and a control logic 129 that governs communications between the various modules of the selection platform 103. In some embodiments, the various modules that are included in the selection platform 103 are one or more sets of executable instructions for execution by a processor or controller, or a programmed computer to perform an indicated functionality.

Profile database 105 is a memory such as a memory 705 (FIG. 7) capable of being queried by selection platform 103 based on a user interaction with the user interface 111. The profile database 105 comprises a profile storage 131, a player list storage 133, and a ranked player list storage 135.

The UE 101, selection platform 103, and profile database 105 are together configured as a special purpose computer system. In some embodiments, one or more of the UE 101, selection platform 103, and profile database 105 are unitarily embodied in the UE 101. The UE 101, accordingly, comprises a processor by which the selection platform 103 is executed. In some embodiments, one or more of the UE 101, selection platform 103 and profile database 105 are configured to be located remotely from each other. If located remotely, the selection platform 103 is executed by a processor that is also positioned remotely from the UE 101 such as another UE 101. By way of example, the UE 101, selection platform 103, and profile database 105 communicate by wired or wireless communication connection and/or one or more networks, or combination thereof.

Based on one or more interactions with the user interface 111, the selection platform 103 generates a user profile that comprises information about a user of the roster management system 100. The selection platform 103 associates the user profile with at least one team of a plurality of teams that together form a league. For example, if a league of teams has 32 teams, a user has the option to select at least one team that selects one or more team-selected players during a player draft with which a list of user-selected players chosen by the user having the generated user profile is to be compared. In some embodiments, the association of the at least one team with which the user profile is associated is based on a selection made by way of a user interaction with user interface 111.

The selection platform 103 monitors the player draft associated with the league. In some embodiments, the selection platform 103 monitors the player draft via direct or indirect communication with a data source associated with, or in communication with, a data source of the league from which information regarding the player draft is received for processing by the selection platform 103. The player draft is an ordered selection process comprising at least one round. At least some teams of the plurality of teams have an assigned draft position within the at least one round, and the assigned draft position is used by a corresponding team to select a player from a list of available players. For example, if all 32 teams in the example league have a draft pick assigned to each team, the teams are predisposed to have an assigned draft position in order from position 1 to 32 in most rounds of the example draft. But, in some rounds, a team might have more than one selection, less than one selection, or the round could have more or less than 32 total selections for various reasons or league actions. In some embodiments, instead of having a player draft in which the teams of the league select players in a predetermined assigned order, teams in an alternative draft style make one or more selections beforehand, and a sorting order is applied to determine the selection of a player for a given team.

As a player draft takes place, each team selects a player from the list of available players. Once a player is selected from the list of available players, the player is no longer available. As such, the selection platform 103 updates the list of available players based on a determined selection of a player by one of the teams of the plurality of teams in the league. The updating of the list of available players comprises removing the selected player from the list of available players. In some embodiments, removing the selected player from the list of available players comprises indicating that a player is unavailable, but allowing the selected player to be viewed in the list of available players. A player is indicated as being unavailable, for example, by being grayed out, being unselectable via user interface 111, listed with a strikethrough, listed in a different color from available players in the list of available players, or other suitable designation.

Upon selection of a player by the at least one team selected to be associated with the user profile, the selection platform 103 identifies the selected player as a team-selected player in a list, a display, a pop-up, in a textual message, or other suitable communication. The team-selected player is selected in the draft position assigned to the at least one team of the plurality of teams associated with the user profile. For example, if the team associated with the user profile is assigned a draft position that selects 15^{th} out of 32 possible draft positions in a particular round of the player draft, the team-selected player is identified and designated as being taken by the team associated with the user profile.

In some embodiments, the selection platform 103 monitors the player draft in real-time such that a user is prompted when the team associated with the user profile is one or more of next up or ready to select (e.g., “on the clock”). In some embodiments, the assigned draft position has an associated time limit, and the selection platform 103 generates an alert signaling the at least one team of the plurality of teams associated with the user profile is tasked with selecting a player within the associated time limit for the assigned draft position. In some embodiments, the user-selected player is selected within a predetermined period following an expiration of the associated time limit, or the selection platform 103 causes the user-selected player to be the same as the team-selected player. In some embodiments, the predetermined period following the expiration of the associated time limit is from about 1 minute to about 10 minutes. In other embodiments, the predetermined period following the expiration of the associated time limit is more than about 10 minutes. In further embodiments, the predetermined period of time following the expiration of the associated time limit is zero, because the user-selected player must be taken within the associated time limit for the assigned draft position. For example, if in a first round, an associated time limit for each draft position is 10 minutes per pick. The team associated with the user profile has 10 minutes to make a selection. Accordingly, in some embodiments, the user-selected player must be taken within the 10 minutes allocated for the assigned draft position that corresponds to the team associated with the user profile.

A team has the option to choose the team-selected player any time within the time window associated with an assigned draft position. So, if a team selects a team-selected player in three minutes, in some embodiments, the selection platform 103 allows the user-selected player to be chosen within the original 10 minute allocated time limit. In other embodiments, the user-selected player must be chosen by the time the team-selected player is chosen, or within a predetermined allowable time period after the team-selected player is chosen, or the selection platform 103 causes the user-selected player to be the same as the team-selected player.

In some embodiments, as each round of the player draft progresses, the time allocated to each assigned draft position in a particular round optionally varies. For example, if first round selections have 10 minutes allocated per pick, second round selections could have 5 minutes allocated per pick. If each of the rounds have different time periods allocated per draft position, in some embodiments, the period of time after the expiration of the time allocated for a draft position varies by a degree corresponding to the time allocated for the draft position per round. For example, if the first round selections have a time window for making a selection of 10 minutes, and the second round selections have a time window for making a selection of 5 minutes, the predetermined period following the expiration of the first round selection for choosing a user-selected player is 10 minutes and the predetermined period following the expiration of the second round selection for choosing a user-selected player is 5 minutes. In other embodiments, the predetermined period is greater than or less than the time allocated per selection per round. In still other embodiments, the predetermined period varies on a per round basis. In other embodiments, the predetermined period does not vary for different rounds.

In some embodiments, the player draft takes place at a predetermined time, and the user-selected player is selected within a predetermined period following a conclusion of the player draft as a whole, or else the user-selected player is caused to be the same as the team-selected player. In some embodiments, the predetermined period following the conclusion of the player draft as a whole is, for example, in a range of about 60 minutes to about one week. If the user-selected player is selected after the player draft as a whole is completed, then selection platform 103 simulates the player draft for the team associated with the user profile so that the list of available players is caused to update as each pick is simulated/displayed via the user interface 111. The selection platform 103 provides the list of available players from which a user-selected player is to be chosen, and the list of available players is updated to reflect the status of the list of available players at the time the team associated with the user profile chose the team-selected player.

Based on one or more user interactions with the user interface 111, a user-selected player is selected, and the selection platform 103, by way of the player selection module 113, stores the user-selected player in the profile database 105. The user-selected player is selected in the draft position assigned to the at least one team of the plurality of teams associated with the user profile. For example, if the selected team associated with the user profile is assigned the draft position that selects 15^{th} out of 32 possible draft positions in a particular round, the user-selected player is selected from the list of available players with the 15^{th} selection in the same round. The user-selected player is one of the same as the team-selected player or a different player available in the list of players at the time the assigned draft position for the team associated with the user profile is tasked with selecting a player. The selection platform 103 updates the list of available players based on the user-selected player by removing the user-selected player from the list of available players. If the user-selected player is different from the team-selected player, both the user-selected player and the team-selected player are removed from the list of available players.

In some embodiments, a user-selected player is optionally the same as a team-selected player, and the designation is made by way of an interaction with the user interface 111 indicating that the user agrees with the team-selected player. The selection platform 103 determines if the user-selected player is the same as the team-selected player based, at least in part, on a detection of the user interaction with the user interface 111 indicating that the user is in agreement with the team-selected player.

In some embodiments, the at least one team of the plurality of teams associated with the user profile has more than one assigned draft position over one or more of the at least one round, at least two rounds, or a plurality of rounds. As such, the selection platform 103 stores more than one user-selected player in the profile database 105. The selection platform 103 is configured to execute one or more of a full-draft selection mode or a scenario selection mode. In the full-draft selection mode, a user has the same number of picks in the player draft as the team associated with the user profile. In the full-draft selection mode, a user-selected player is taken or determined for each pick in the player draft that is assigned to the team associated with the user profile. Accordingly, a first quantity of team-selected players is equal to a second quantity of user-selected players.

In the scenario selection mode, a user is faced with a given draft scenario such as a challenge to pick a player in the fourth round of a draft based on the team-selected players taken by the team associated with the user profile before the fourth round selection. The scenario selection mode puts the user in the shoes of the team general manager, for example, and pits the user against the general manager in a given scenario or draft condition which would be more minute than an overall draft performance comparison. The scenario selection mode puts pressure on a user, for example, to avoid taking players that might not be an immediate need for a team based on what team-selected players have been taken already. For example, if a team has already chosen two team-selected linebackers in the first three rounds of a draft, and the user would normally like to select a linebacker in the fourth round, the team may not need a linebacker based on the previous two team-selected linebackers. As such, the user is challenged to choose the next user-selected player while taking the already chosen team-selected players into consideration. In some embodiments, if the selection platform 103 is executing both the full-draft selection mode and the scenario selection mode, the selection platform 103 maintains and updates two separate lists of available players for each of the selection modes.

In some embodiments, a quantity of user-selected players chosen in the scenario selection mode is less than or equal to the quantity of team-selected players. In some embodiments, the scenario selection mode is executed by the selection platform 103 for each draft position assigned to the team associated with the user profile. In some embodiments, the scenario selection mode is executed by the selection platform 103 for a lesser quantity of specific challenge selections. For example, in a seven round league draft, rounds 2, 4, and 6 could be preset as challenge selections.

In some embodiments, as the user and the team associated with the user profile compile players through the player draft, the selection platform 103 generates a first list comprising at least one team-selected player and a second list comprising at least one user-selected player. The selection platform 103, in some embodiments, causes the first list and the second list to be displayed side-by-side by way of user interface 111 to make it possible to compare the first list to the second list. In some embodiments, the selection platform 103 identifies differences between the first list and the second list displays the differences between the first list and the second list. In some embodiments, the selection platform 103 causes the differences between the first list and the second list to be highlighted in a display by way of user interface 111. In some embodiments, if the selection platform 103 is executing both the full-draft selection mode and the scenario selection mode, the user-selected players from both the full-draft selection more and the scenario selection mode are included in the second list. In some embodiments, the user-selected players from both the full-draft selection more and the scenario selection mode are included side-by-side in the second list. In some embodiments, the user-selected players from both the full-draft selection more and the scenario selection mode are separated into two separate sub-lists of the second list for individual comparison with the first list comprising the at least one team-selected player.

In some embodiments, once stored, the user-selected player list stored in the database 105 is fixed or unalterable. Such permanence of the user-selected player list makes it possible to verify after the player draft is complete that a user selected a player at a particular time faced with the same available player options that the team associated with the user profile had when the team-selected player was chosen, and before the user-selected player and/or the team selected player began their respective careers beyond the draft. In some embodiments, the user-selected player is time-stamped with a date and/or time indicating when the user-selected player is stored in the database 105. In some embodiments, the user-selected player is stored in the database 105 with a time-stamp indicating a date and/or time of when the user-selected player was selected. In some embodiments, the time-stamp stored in the database 105 with the user-selected player is encrypted to secure the authenticity of the time-stamp. In some embodiments, the user-selected player is included in a displayed list of user-selected players with the stored time-stamp.

The list of available players is displayed by way of user interface 111. In some embodiments, the list of available players is capable of being ranked in order of a user-defined preference one of before, during, or after the player draft. For example, the selection platform 103 modifies the list of available players based on one or more interactions with user interface 111 and, before the player draft occurs, the selection platform 103 stores a time-stamped ranked list of available players in the database 105 and links the time-stamped ranked list of available players with the user profile. Such a time-stamped list of available players is presentable, for example, to indicate that a user considered certain players to be better than other players before any other teams or the team associated with the user profile made one or more selections during the player draft. Similarly, as the player draft progresses, the selection platform 103 optionally stores a time-stamped list of available players following a re-organization or re-ranking of players as the draft selection process removes available players, and the user re-sorts or re-ranks at least some of the remaining players. In some embodiments, the selection platform 103 shares the ranked list of available players by way of a social networking service.

In some embodiments, the list of available players is further capable of being sorted or highlighted based on one or more of a player position, a player height, a player weight, a player body mass index, a player speed, a player scouting report score, a player school, a player age, a player ethnicity, a player gender, a player injury report, or other suitable criteria. In further embodiments, the selection platform 103 makes it possible to store user-input notations associated with one or more players in the list of available players, and have the user-input notations stored in the database 105 such that the user-input notations are associated with the user-profile and recalled based on a user selection to view the user-input notations.

In some embodiments, if the team associated with the user profile trades its assigned draft position or acquires an assigned draft position of another team, the draft position assigned to the at least one team associated with the user profile is therefore movable within or removable from the player draft. If the draft position assigned to the at least one team associated with the user profile is moved within the player draft from a first draft position to one or more other draft positions newly assigned to the at least one team associated with the user profile within the player draft, the selection platform 103 recognizes this change in assigned draft position(s), generates an alert indicating the change, and selection platform 103 designates the user-selected player to be selected in one of the one or more other draft positions assigned to the at least one team associated with the user profile by the selection platform 103.

In some embodiments, the selection platform 103 tracks one or more user-selected players among one or more users to generate an estimate of a next-selected player out of the available players included in the list of available players that is to be next selected by a team of the plurality of teams, the at least one team associated with the user profile, or selected as a user-selected player. The selection platform 103 optionally communicates the estimate of the next-selected player to the user interface 111. In some embodiments, the estimate of the next-selected player is shared with one or more users, one or more teams, and/or a social networking service. For example, an estimated next-selected player is the product of aggregated user selection data collected from a plurality of system users and makes it possible for sports, broadcasting, entertainment and news businesses to communicate consumer thoughts and preferences regarding draft selections in real-time while the player draft is occurring similar to a polling or voting system.

In some embodiments, the selection platform 103 is configured to process performance statistics associated with the user-selected player and the team-selected player to determine if the at least one team associated with the user profile should have taken the user-selected player. The performance statistics comprise one or more of games played, games started, win-loss record of the actual team that drafted the player, player game statistics, captaincy selections, all-star selections, all-pro selections, pro-bowl selections, or other suitable criteria.

In some embodiments, the selection platform 103 stores one or more user-selected players in the database 105 for a plurality of player drafts, scores the one or more user-selected players stored in the database based on accumulated performance statistics, and assigns an overall score associated with the user profile indicating an overall performance of the user-selected players versus one or more of the at least one team associated with the user profile, the league as a whole, or one or more other users. In some embodiments, the selection platform 103 is associated with a social networking service that displays the user profiles, and the selection platform 103 displays the overall score with the display of the user profile.

In some embodiments, the selection platform 103 is configured to output a user-performance record that shows a comparison of the user-selected players over time compared the team-selected player to be shared with one or more teams as a part of a resume of sorts for showcasing a user's capabilities in selecting quality players from the list of available players under the same selection criteria that the team associated with the user profile was under at the time the team-selected players were chosen.

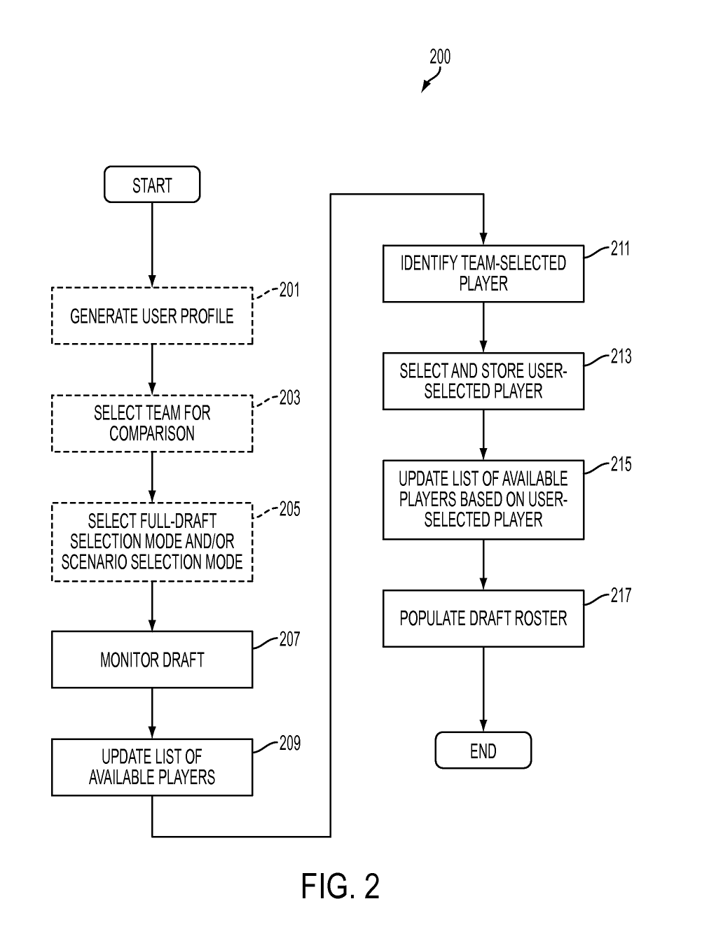

FIG. 2 is a flowchart of a method 200 of amassing and assessing a user-selected draft roster, in accordance with one or more embodiments.

In step 201, the selection platform 103 (FIG. 1) optionally generates a user profile upon receipt of an instruction to generate a user profile that is based, at least in part, on an interaction with the user interface 111 (FIG. 1). The user profile comprises data such as user identification information, user biographic data, other user related data, user behavior, user preferences, user capabilities, user assessments, user-selected players, and/or other suitable information usable in the roster management system 100 (FIG. 1). The selection platform 103 stores the user profile in the profile database 105 (FIG. 1). In some embodiments, generating a user profile is a prerequisite to choosing user-selected players. In other embodiments, user-selected players are capable of being chosen without generating a user profile. In some embodiments, if a user profile was previously generated or is not a prerequisite to choosing user-selected players, the method 200 skips to a subsequent step.

In step 203, based on an interaction with the user interface 111, the user optionally selects at least one team with which the user opts to compare player selections. In some embodiments, a selection to compete against all of the teams of the league is possible, and accordingly, the method 200 skips to a subsequent step. In some embodiments, only one team is capable of being selected to be compared to the user-selected players. In further embodiments, if at least one team had been previously chosen to be compared to the user-selected players, then the method 200 skips to a subsequent step. The selection platform 103, accordingly, causes the user profile to be associated with the selected at least one team of the plurality of teams that together form the league. In some embodiments, before selecting a team, the user interface 111 provides an option to first select a sport and/or a league. In some embodiments, the user interface 111 is fixed with respect to a specific sport and/or league such that a predetermined set of teams is displayed for user selection via user interface 111.

In step 205, based on an interaction with the user interface 111, the user optionally selects one or more of a full-draft selection mode or a scenario selection mode for choosing user-selected players. In some embodiments, if the scenario selection mode is chosen, one or more challenge selections are pre-set or designated. If the one or more challenge selections or draft positions are pre-set, the selection platform 103 notifies the user which selections are challenge selections. In some embodiments, the challenge selections are unknown to the user until the team associated with the user profile is on the clock. In some embodiments, based on an interaction with user interface 111, the user optionally picks which draft positions are to be designated as challenge selections. In some embodiments, if the full-draft selection mode and the scenario selection mode are both selected, the full-draft selection mode and the scenario selection mode are executed in parallel with one another, and are subject to the same rules for choosing a user-selected player. In some embodiments, if both modes are executed in parallel, a predetermined allowable time period for choosing a user-selected player is optionally allotted to provide more time for making user-selected player selections for both the full-draft selection mode and the scenario selection mode.

In step 207, the player draft begins and the selection platform 103 monitors the player draft associated with the league. The player draft is an ordered selection process comprising at least one round. At least some teams of the plurality of teams in the league have an assigned draft position within the at least one round. The assigned draft position is used by a corresponding team to select a player from a list of available players. After a player is selected in an assigned draft position by a team of the plurality of teams, each player selected is no longer available for another team, or the same team, to later select. Accordingly, in step 209, the selection platform 103 updates the list of available players based on a determined selection of a player by one of the teams of the plurality of teams. The selection platform 103 updates the list of available players by, for example, removing the selected player from the list of available players, or otherwise rendering the selected player unavailable in the list of available players.

In step 211, the selection platform 103 identifies a team-selected player that is chosen by the team with which the user opted to compare player selections. In some embodiments, the selection platform 103 indicates that the team associated with the user profile is next to pick or is tasked with picking a player (or “on the clock”). Once the assigned draft position for the team associated with the user profile is on the clock, a team-selected player is taken from the listed of available players made available to the team associated with the user profile for the particular assigned draft position. If the team associated with the user profile trades the assigned draft position, no team-selected player is chosen in the assigned draft position that is traded away, and accordingly, no user-selected player is chosen in the assigned draft position that was traded away. Rather, if the team associated with the user profile has another pick in the player draft, then the next opportunity for a user-selected player to be chosen will be the next assigned draft position that corresponds to the team associated with the user profile, pending any future trades.

In step 213, the user, by way of the user interface 111, optionally selects, as a user-selected player in either or both of the full-draft selection mode or the scenario selection mode, the team-selected player via agreement with the team-selected player, other independent action, or time period expiration. Alternatively, the user, by way of the user interface 111, selects a different player from the list of available players at the time the assigned draft position for the team associated with the user profile is on the clock as the user-selected player in either or both of the full-draft selection mode or the scenario selection mode. The selection platform 103 stores the user-selected player in the profile database 105. The selection platform 103 also stores the team-selected player in the profile database 105 for comparison to the user-selected player.

In step 215, the selection platform 103 updates the list of available players based on the user-selected player by removing the user-selected player from the list of available players. In some embodiments the user-selected player is the same as the team-selected player, so only one player is removed from the list of available selections by the selection platform 103 to update the list of available players. In other embodiments, the user-selected player is different from the team-selected player. Accordingly, the selection platform 103 removes the user-selected player that is different from the team-selected player in addition to removing the team-selected player from the list of available players to update the list of available players. As such, in some cases two players are removed from the list of available players following a selection made for an assigned draft position. If both the full-draft selection mode and the scenario selection mode are being executed by the platform 103, the selection platform 103 maintains and updates the list of available players as two independent lists for each selection mode.

In step 217, the selection platform 103 facilitates the option of populating a draft roster with a quantity of players equal to the quantity of assigned draft positions the team associated with the user profile has among the one or more rounds of the player draft in the full-draft selection mode and/or equal to a quantity of challenge selections designated to be made in the scenario selection mode. In the full-draft selection mode, steps 209-215 repeat for each round of the player draft until the draft is complete. In the scenario selection mode, steps 209-215 repeat as necessary until a user-selected player is chosen or determined for each of the designated challenge selections. The selection platform 103 populates a draft roster developed by a user with one or more user-selected players that are the same or different from the team-selected players and stores all of the user-selected players and the team-selected players in the profile database 105. If the selection platform 103 is directed to execute the full-draft selection mode, and the team associated with the user profile has seven assigned draft positions in the player draft, the team-selected player quantity is seven, and the user-selected player quantity is seven. In the scenario selection mode, the user-selected player quantity is equal to the quantity of challenge selections. If both the full-draft selection mode and the scenario selection mode are being executed by the selection platform 103, the selection platform 103 populates draft rosters for both the full-draft selection mode and the scenario selection mode.

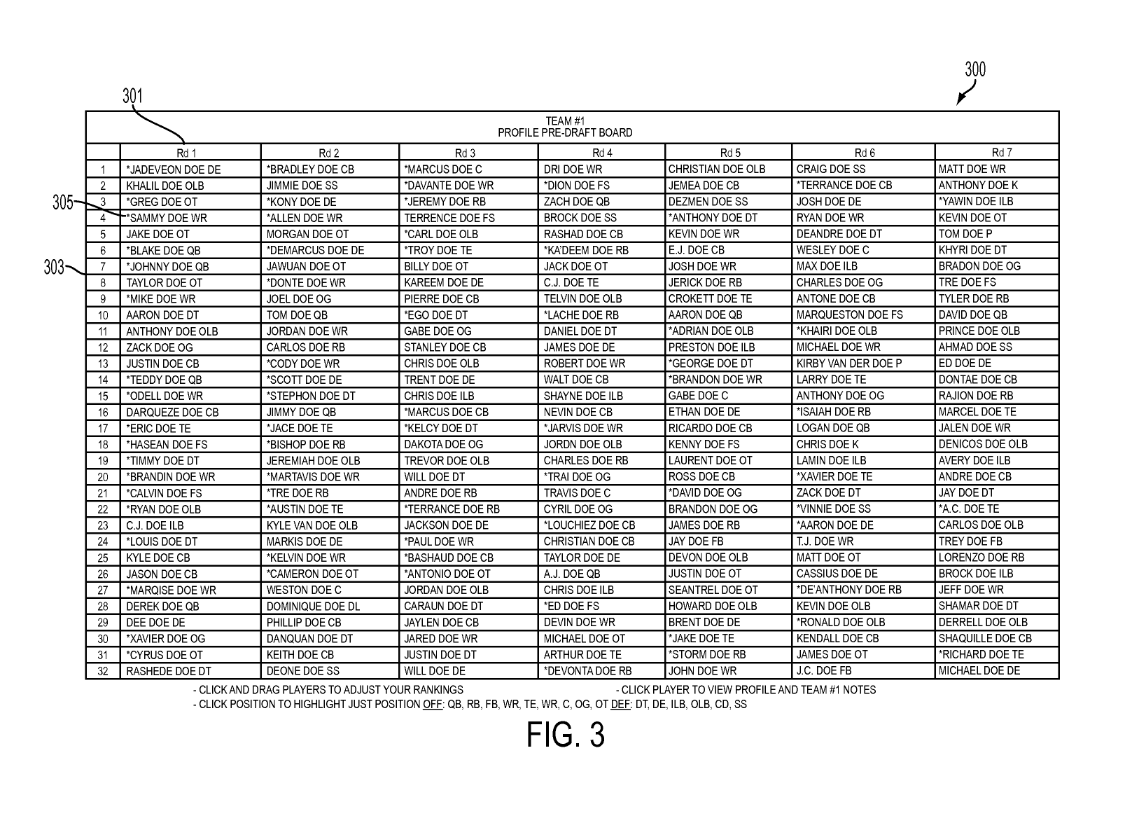

FIG. 3 is a diagram of a user interface 300 used to rank a list of available players, in accordance with one or more embodiments. User interface 300 is accessible by way of user interface 111.

The user interface 300 is a list of available players that is capable of being ranked, edited, notated, stored, and/or shared before, during, or after commencement of the player draft. The user interface 300 is, for example, a “draft board” that is accessible within the roster management system 100. The user interface 300 comprises a list that is segmented into the number of rounds 301 included in the player draft, and the number of assigned draft positions 303 per round. In some embodiments, the user interface 300 is pre-populated with a plurality of available players 305 that the teams partaking in the player draft are likely to select. In some embodiments, the pre-populated user interface 300 includes players 305 that are arranged in a default ranking that is predetermined based on a likelihood that a player 305 will be a quality player in the future. In other embodiments, the user interface 300 includes players 305 that are arranged in alphabetical order, by position, by age, by school, by height, by weight, by speed, by scouting report score, or other suitable quantifier. In some embodiments, the user interface 300 is randomly populated with players 305. In further embodiments, the user interface 300 is blank and is configured to be populated entirely by the selection platform 103 (FIG. 1) based on user interaction with the user interface 111 (FIG. 1). In some embodiments, the user interface 300 is at least partially populated with players 305.

Whether pre-populated with players 305 or not, once the user interface 300 includes one or more players 305, the selection platform 103, in some embodiments, makes it possible to rank, sort, add, delete, and/or arrange the players 305 within the user interface 300. In some embodiments, the selection platform 103 processes a user interaction such as touching, pointing, clicking, dragging, a voice input, a textual input, or other interaction with the user interface 300 to adjust the rankings, sorting and/or arrangement of player 305 at any time. In some embodiments, the user interface 300 includes player profiles that are accessible, for example, as a drill-down menu. Based on a an interaction with user interface 300, the selection platform 103 displays information about a player 305 such as biographic information, scouting report data, school/farm system or team, experience level, position, grade point average, academic major, aptitude test scores, or other player-related information usable to assess a player's probable success. In some embodiments, the user interface 300 also includes a notation section within which a user, by way of user interface 300, optionally adds notes regarding the player 305 whose profile is being displayed. The selection platform 103 stores the notes in the profile database 105 for later recall. In some embodiments, the user interface 300 also include videos associated with the player 305 whose profile is being displayed, such as performance videos, game recordings, or other media such as pictures, or audio recordings.

In some embodiments, the user interface 300 is sortable based on one or more of position, height, weight, gender, ethnicity, school/farm system or team, scouting report data or score, age, experience level, aptitude test score, or other sortable information. Once sorted, the user interface 300 makes it possible to rank players 305 within a sub-category such as position. In some embodiments, the user interface 300 highlights or makes a selected category of players stand out over other players. For example, if a particular player position is selected for highlighting, regardless of placement within the user interface 300, the selection platform 103 causes all of the players that play the selected position to be highlighted or made to stand out versus the other players listed in the user interface 300. For example, if quarterback is selected, and among the 224 players included in the example user interface 300, there are 16 quarterbacks, then all of the 16 quarterbacks are highlighted to stand out among the player 305 listed in the user interface 300. Similarly, other sortable criteria is optionally selectable to highlight one or more players as arranged in the user interface 300.

In some embodiments, more than one criterion is selectable for highlighting a player. For example, if quarterback is selected as the highlightable player position, a player height range is optionally set to be greater than 6′-2″ but less than 6′-7″, and an aptitude test score of greater than 30 is selected, the selection platform 103 highlights player meeting all of the criteria. In some embodiments, the user interface 300 is configured to also highlight players that are within a predefined tolerance of the selected criteria in a same or a different highlighting scheme. For example, if some players are a 100% match to the selected criteria, then the selection platform 103 causes those players to be highlighted in green, and if some other players are greater than a 75% match, but less than a 100% match, then the selection platform 103 causes those players to be highlighted in yellow. In some embodiments, more than one highlighting scheme is capable of being set at a time. For example, if a user selects a first player position such as quarterback, and a second player position such as running back, the selection platform 103 highlights players 305 having the selected positions in a same highlighting scheme, or in a different highlighting scheme that corresponds to the selected position. Such a capability is useful, for example, if a user is identifying one or more “needs” for a team to focus on during the player draft. In some embodiments, the user interface 300 includes a “needs” column within which one or more players 305 are capable of being added to or identified within to meet certain positional needs that a team might have.

In some embodiments, the user interface 300 is preset to be color-coded based on one or more player criteria such as a player position. For example, in some embodiments, quarterbacks are colored green, running backs are colored red, wide receivers are colored orange, defensive backs are colored purple, etc.

In some embodiments, the user interface 300 is capable of being stored and time-stamped before, during, and/or after the player draft. For example, a time-stamped user interface 300 might serve as proof that a user had identified a particular player as having a higher probability of success than another player over those players' careers.

In some embodiments, user interface 300 serves as user interface 111 with which a user interacts to select user-selected players over the course of the player draft. As players are selected by the teams of the plurality of team in the league and/or the user, the selection platform 103 updates the user interface 300 to indicate that a player 300 is no longer available for selection by, for example, removing the player from the user interface 300, moving the selected player to the assigned draft position 303 within the round 301 that the player 305 is selected, graying-out the selected player 305, or other suitable indication that a player is unavailable.

In some embodiments, the user interface 300 is capable of being shared with one or more other users, for example, if one or more users opt to compare draft boards before, during or after the player draft. In some embodiments, the user interface 300 is tied to the user profile and displayed along with or as a part of at least a portion of a display of the user profile. In some embodiments, a user's success rate is tabulated and scored versus the team associated with the user profile, the league, and/or one or more other users to define a user performance score. The user performance score is optionally displayed along with the user profile, or as a portion of the user profile that is included in the display of user interface 300. If, for example, a user has a performance score that indicates the user is a better drafter than some other users, the user performance score adds credibility to the user whose user interface 300 is being displayed and/or shared.

In some embodiments, the user profile or the user interface 300 includes an archive of previous user interfaces 300 that are accessible by a tab selection, activated link or button, or other direction. The selection platform 103, based on an interaction with the user interface 111 which displays the user interface 300, causes a selected archived user interface 300 to be selectively displayed. In some embodiments, the selection platform 103 causes a list comprising the user-selected players to be displayed in user interface 300 and/or user profile alone, or side-by-side with a list of team-selected players for comparison.

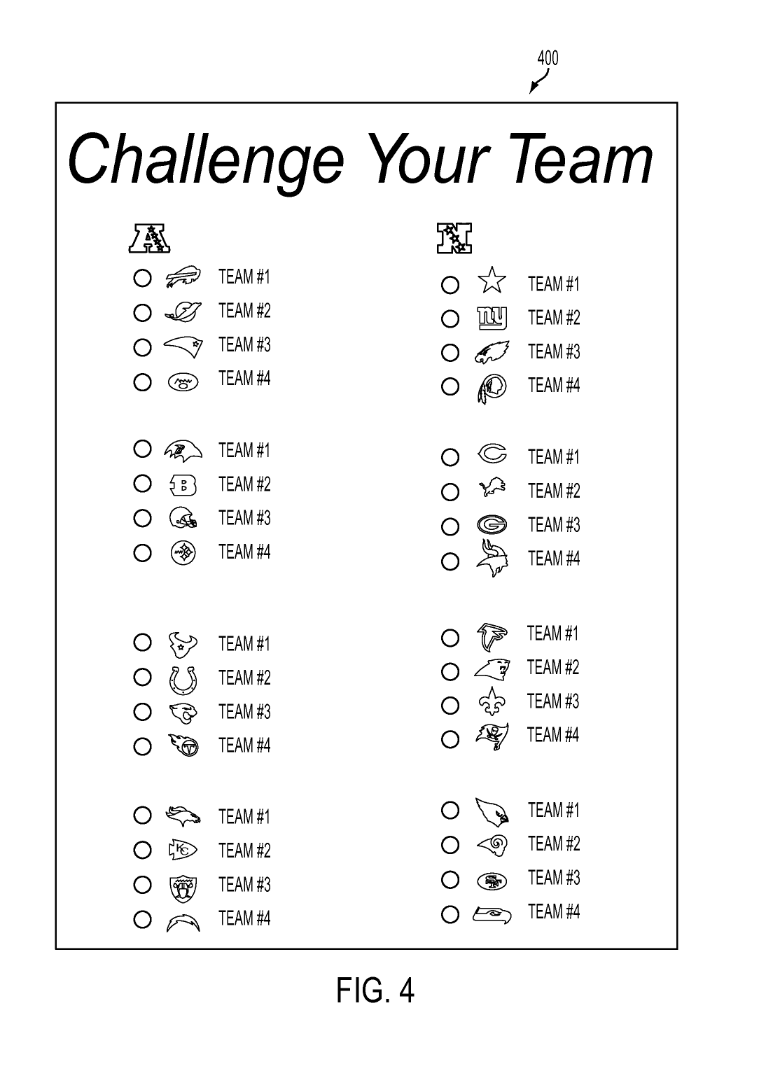

FIG. 4 is a diagram of a user interface 400 used to identify a team to be associated with a user profile, in accordance with one or more embodiments. User interface 400 is accessible by way of user interface 111 (FIG. 1).

User interface 400 is populated with a plurality of teams that form a league. The plurality of teams in the league partake in the player draft. The selection platform 103, based on an interaction with the user interface 400, associates a selected team with the user profile such that the selected team is tracked for identifying team-selected players, indicating that the selected team is at least one of next up or on the clock with respect to the selected teams assigned draft position, and/or for comparing user-selected players to team-selected players.

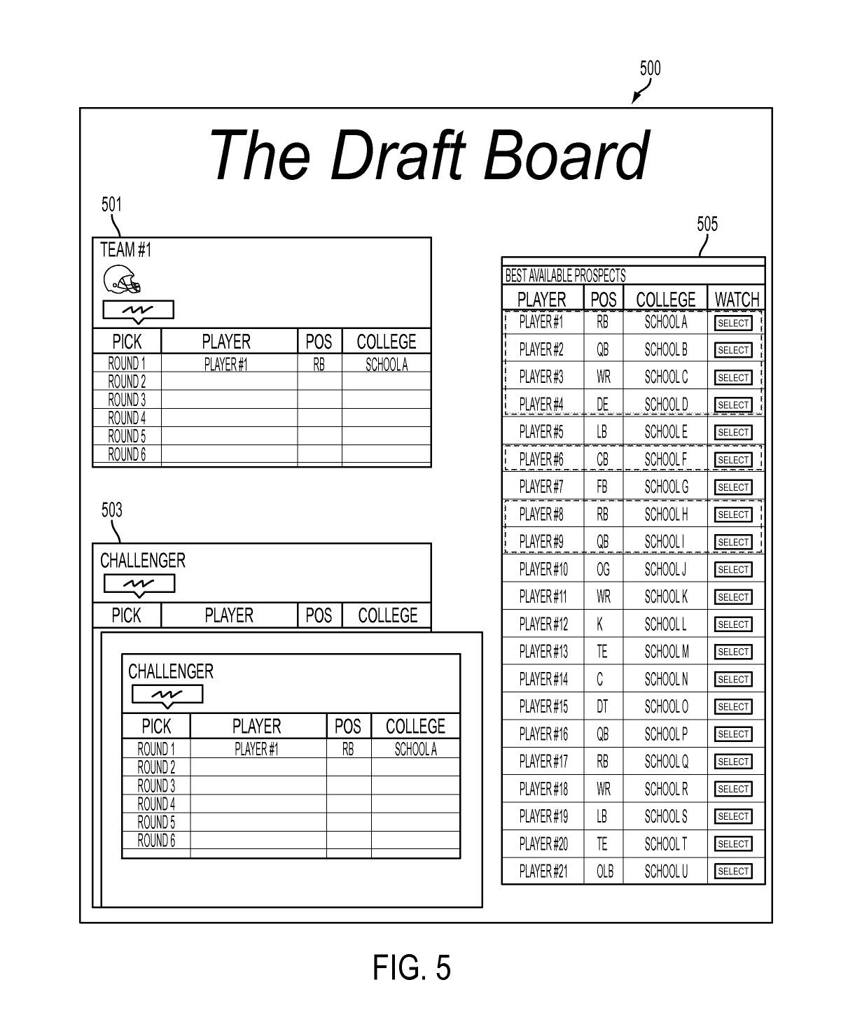

FIG. 5 is a diagram of a user interface 500 used to select a player from a list of available players, in accordance with one or more embodiments. User interface 500 is accessible by way of user interface 111 (FIG. 1).

User interface 500 includes a team-selected player list 501, at least one user-selected player list 503, and a list of available players 505. The selection platform 103 (FIG. 1), monitors the player draft and identifies a team-selected player at least by populating the team-selected player list 501 with the team-selected player upon selection. In some embodiments, the selection platform 103 causes an alert such as a pop-up including text, a scrolling banner including text, an audio alert, a video alert, or other suitable indicator for identifying that a team-selected player has been chosen. Similarly, the selection platform 103 causes an alert such as a pop-up including text, a scrolling banner including text, an audio alert, a video alert, or other suitable indicator for indicating that the team associated with the user profile is at least next to pick or on the clock.

The selection platform 103, in some embodiments, provides an option to agree or disagree with the team-selected player to choose the user-selected player. In some embodiments, a user-selected player, regardless of whether the player is the same or different from the team-selected player, is chosen from the list of available players 505 by an interaction with the user interface 500 such as pointing, clicking, voice command, or other suitable interaction. In this example, players are indicated as being unavailable by way of highlighting (e.g., the highlighted players were previously selected in a different assigned draft position during the player draft). Upon selection, the selection platform 103 causes the user-selected player list(s) 503 to be populated with the user-selected player(s) for the full-draft selection mode and/or the scenario selection mode. In some embodiments, if both the full-draft selection mode and the scenario selection mode are executed by the selection platform 103, the user-selected player list 503 is a single list that includes user-selected players made for both of the full-draft selection mode and the scenario selection mode.

In some embodiments, the user interface 500 includes a draft timer that indicates the amount of time allotted for making at least the team selection. In some embodiments, the user interface 500 includes an overtime clock that indicates a predetermined period of time after the assigned draft position or after the team-selected player is chosen within which the user-selected player is to be chosen.

In some embodiments, a user-selected player is chosen for only selective picks, for example, the first round and the 3^{rd} round, such as in the scenario selection mode. In some embodiments, a particular pick for selection is designated as a challenge selection or highlighted in the user-selected player list 503 to draw a user's attention to the challenge selection. In other embodiments, the user-selected players are chosen for all of the assigned draft positions that correspond to the team associated with the user profile in either of the scenario selection mode or the full-draft selection mode.

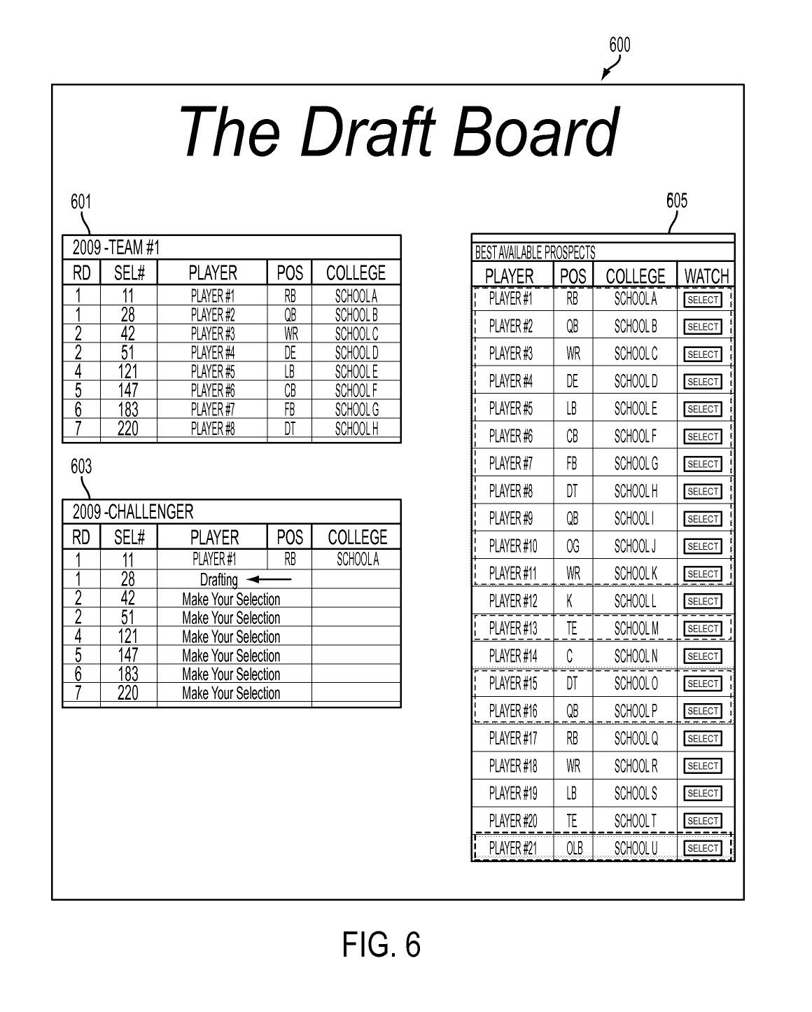

FIG. 6 is a diagram of user interface 600 used in a post-draft simulation, in accordance with one or more embodiments. User interface 600 is accessible by way of user interface 111 (FIG. 1) and includes the same elements as user interface 500 (FIG. 5) increased by 100.

User interface 600 illustrates the team-selected player list 601 and the user-selected player list 603 in a post-draft simulation (i.e. after the player draft is completed, or during the player draft, but after one or more picks have been completed by the team associated with the user profile) that is executed by the selection platform 103. The user-selected player list 603 is populated only with players that the user has selected. The team-selected player list 601 is populated with team-selected players up to the point at which the user has joined the player draft. If the draft is complete, then the team-selected player list 601 is fully populated with the team-selected players chosen during the player draft. In some embodiments, the team-selected player list 601 is unpopulated at least until a user-selected player is chosen that corresponds to the assigned draft position that is on the clock in the pose-draft simulation.

As the post-draft simulation progresses through each assigned draft position, the selection platform 103 updates the list of available players 605 to indicate which players were available for the assigned draft position that is on the clock. For example, if the post-draft simulation takes place a day after completion of the player draft, the list of available players 605 is updated to indicate which players were available at the time a team-selected player was taken with the 16^{th} overall assigned draft position. Then, the post-draft simulation advances to the next assigned draft position that corresponds to the team associated with the user profile. If the next assigned draft position is the 42^{nd} overall assigned draft position, then the list of available players 605 is updated to indicate which players were available at the time a team-selected player was taken with the 42^{nd} overall pick and so on. Accordingly, the user-selected player chosen in each assigned draft position that corresponds to the team associated with the user profile is selected from the same pool of players that were available to the team associated with the user profile for each assigned draft position.

In some embodiments, if the post-draft simulation is executed during the real-time player draft, then the selection platform 103 executes the post-draft simulation until the user catches-up with the real-time player draft, at which point, user-selected players are to be chosen based on the assigned draft position that corresponds to the team associated with the user profile within the predetermined period of time allotted for the assigned draft position or after the assigned draft position.

FIG. 7 is a functional block diagram of a computer or processor-based system 700 upon which or by which an embodiment is implemented.

Processor-based system 700 is programmed to monitor a player draft, facilitate choosing a user-selected player from a list of available players, update the list of available players, store the user-selected player in a database and compare the user-selected player with a team-selected player, as described herein, and includes, for example, bus 701, processor 703, and memory 705 components.

In some embodiments, the processor-based system is implemented as a single “system on a chip.” Processor-based system 700, or a portion thereof, constitutes a mechanism for performing one or more steps of monitoring a player draft, facilitating choosing a user-selected player from a list of available players, updating the list of available players, store the user-selected player in a database and comparing the user-selected player with a team-selected player

In some embodiments, the processor-based system 700 includes a communication mechanism such as bus 701 for transferring information and/or instructions among the components of the processor-based system 700. Processor 703 is connected to the bus 701 to obtain instructions for execution and process information stored in, for example, the memory 705. In some embodiments, the processor 703 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 703. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 703 performs a set of operations on information as specified by a set of instructions stored in memory 705 related to monitoring a player draft, facilitating choosing a user-selected player from a list of available players, updating the list of available players, storing the user-selected player in a database and comparing the user-selected player with a team-selected player. The execution of the instructions causes the processor to perform specified functions.

The processor 703 and accompanying components are connected to the memory 705 via the bus 701. The memory 705 includes one or more of dynamic memory (e.g., RAM, magnetic disk, writable optical disk, etc.) and static memory (e.g., ROM, CD-ROM, etc.) for storing executable instructions that when executed perform the steps described herein to monitor a player draft, facilitate choosing a user-selected player from a list of available players, update the list of available players, store the user-selected player in a database and compare the user-selected player with a team-selected player. The memory 705 also stores the data associated with or generated by the execution of the steps.

In one or more embodiments, the memory 705, such as a random access memory (RAM) or any other dynamic storage device, stores information including processor instructions for monitoring a player draft, facilitate choosing a user-selected player from a list of available players, updating the list of available players, storing the user-selected player in a database and comparing the user-selected player with a team-selected player. Dynamic memory allows information stored therein to be changed by system 100. RAM allows a unit of information stored at a location called a memory address to be stored and retrieved independently of information at neighboring addresses. The memory 705 is also used by the processor 703 to store temporary values during execution of processor instructions. In various embodiments, the memory 705 is a read only memory (ROM) or any other static storage device coupled to the bus 701 for storing static information, including instructions, that is not changed by the system 100. Some memory is composed of volatile storage that loses the information stored thereon when power is lost. In some embodiments, the memory 705 is a non-volatile (persistent) storage device, such as a magnetic disk, optical disk or flash card, for storing information, including instructions, that persists even when the system 100 is turned off or otherwise loses power.

The term “computer-readable medium” as used herein refers to any medium that participates in providing information to processor 703, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description relates to a method performed by a processor. The method comprises generating a user profile in a roster management system, the user profile being associated with at least one team of a plurality of teams, the plurality of teams together forming a league. The method also comprises monitoring a player draft associated with the league, the player draft being an ordered selection process comprising at least one round, wherein at least some teams of the plurality of teams have an assigned draft position within the at least one round, and the assigned draft position is used by a corresponding team to select a player from a list of available players. The method further comprises updating the list of available players based on a determined selection of a player by one of the teams of the plurality of teams, the updating comprising removing the selected player from the list of available players.

The method additionally comprises identifying a team-selected player, the team-selected player being a player selection made by the at least one team of the plurality of teams associated with the user profile, the team-selected player being selected in the draft position assigned to the at least one team of the plurality of teams associated with the user profile. The method also comprises storing a user-selected player in a database, the user-selected player being selected in the draft position assigned to the at least one team of the plurality of teams associated with the user profile, the user-selected player being selected from the list of available players. The method further comprises updating the list of available players based on the user-selected player by removing the user-selected player from the list of available players.

Another aspect of this description relates to an apparatus comprising at least one processor and at least one memory including computer program code for one or more programs. The at least one processor is configured to execute an instruction from the at least one memory to cause the apparatus to generate a user profile in a roster management system, the user profile being associated with at least one team of a plurality of teams, the plurality of teams together forming a league. The apparatus is also caused to monitor a player draft associated with the league, the player draft being an ordered selection process comprising at least one round, wherein at least some teams of the plurality of teams have an assigned draft position within the at least one round, and the assigned draft position is used by a corresponding team to select a player from a list of available players. The apparatus is further caused to update the list of available players based on a determined selection of a player by one of the teams of the plurality of teams, the updating comprising removing the selected player from the list of available players.

The apparatus is additionally caused to identify a team-selected player, the team-selected player being a player selection made by the at least one team of the plurality of teams associated with the user profile, the team-selected player being selected in the draft position assigned to the at least one team of the plurality of teams associated with the user profile. The apparatus is also caused to store a user-selected player in a database, the user-selected player being selected in the draft position assigned to the at least one team of the plurality of teams associated with the user profile, the user-selected player being selected from the list of available players. The apparatus is further caused to update the list of available players based on the user-selected player by removing the user-selected player from the list of available players.

A further aspect of this description relates to a non-transitory computer-readable storage medium comprising computer-readable instructions which, when executed by a processor, cause the processor to generate a user profile in a roster management system, the user profile being associated with at least one team of a plurality of teams, the plurality of teams together forming a league. The processor is also caused to monitor a player draft associated with the league, the player draft being an ordered selection process comprising at least one round, wherein at least some teams of the plurality of teams have an assigned draft position within the at least one round, and the assigned draft position is used by a corresponding team to select a player from a list of available players. The processor is further caused to update the list of available players based on a determined selection of a player by one of the teams of the plurality of teams, the updating comprising removing the selected player from the list of available players.

The processor is additionally caused to identify a team-selected player, the team-selected player being a player selection made by the at least one team of the plurality of teams associated with the user profile, the team-selected player being selected in the draft position assigned to the at least one team of the plurality of teams associated with the user profile. The processor is also caused to store a user-selected player in a database, the user-selected player being selected in the draft position assigned to the at least one team of the plurality of teams associated with the user profile, the user-selected player being selected from the list of available players. The processor is further caused to update the list of available players based on the user-selected player by removing the user-selected player from the list of available players.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method performed by a processor, the method comprising:
generating a user profile in a roster management system, the user profile being associated with at least one team of a plurality of teams, the plurality of teams together forming a league;
monitoring a player draft associated with the league, the player draft being an ordered selection process comprising at least one round, wherein at least some teams of the plurality of teams have an assigned draft position within the at least one round, and the assigned draft position is used by a corresponding team to select a player from a list of available players;
updating the list of available players based on a determined selection of a player by one of the teams of the plurality of teams, the updating comprising removing the selected player from the list of available players;
identifying a team-selected player, the team-selected player being a player selection made by the at least one team of the plurality of teams associated with the user profile, the team-selected player being selected in the draft position assigned to the at least one team of the plurality of teams associated with the user profile;
storing a user-selected player in a database, the user-selected player being selected in the draft position assigned to the at least one team of the plurality of teams associated with the user profile, the user-selected player being selected from the list of available players; and
updating the list of available players based on the user-selected player by removing the user-selected player from the list of available players.

2. The method of claim 1, wherein the at least one team of the plurality of teams associated with the user profile has more than one assigned draft position over one or more of the at least one round, at least two rounds, or a plurality of rounds, the method further comprising:
storing more than one user-selected player in the database,
wherein a first quantity of team-selected players is equal to a second quantity of user-selected players.

3. The method of claim 1, further comprising:
generating a first list comprising at least one team-selected player;
generating a second list comprising at least one user-selected player; and
comparing the first list to the second list.

4. The method of claim 3, wherein the second list is unalterable.

5. The method of claim 1, wherein the monitoring of the player draft occurs in real-time, the assigned draft position has an associated time limit, and the method further comprises:
generating an alert signaling the at least one team of the plurality of teams associated with the user profile is tasked with selecting a player within the associated time limit for the assigned draft position.

6. The method of claim 5, wherein the user-selected player is selected within a predetermined period following an expiration of the associated time limit, or the user-selected player is caused to be the same as the team-selected player.

7. The method of claim 1, wherein the user-selected player is stored with a time stamp indicating a date and time of when the user-selected player was selected.

8. The method of claim 1, wherein the list of available players is displayed by way of a user interface.

9. The method of claim 8, wherein the list of available players is capable of being ranked in order of a user-defined preference one of before, during, or after the player draft.

10. The method of claim 9, further comprising:
storing a time-stamped ranked list of available players in the database; and
linking the time-stamped ranked list of available players with the user profile.

11. The method of claim 9, further comprising:
storing a ranked list of available players in the database;
linking the ranked list of available players with the user profile; and
sharing the ranked list of available players by way of a social networking service.

12. The method of claim 9, wherein the list of available players is further capable of being sorted based on one or more of a player position, a player height, a player weight, a player body mass index, a player speed, a player scouting report score, a player school, a player age, a player ethnicity, a player gender, or a player injury report.

13. The method of claim 9, further comprising:
storing a rankable list of available players in the database;
linking the rankable list of available players in the database; and
storing user-input notations associated with one or more players in the list of available players.

14. The method of claim 1, wherein the draft position assigned to the at least one team of the plurality of teams associated with the user profile is movable within or removable from the player draft by the at least one team of the plurality of teams associated with user profile.

15. The method of claim 14, wherein if the draft position assigned to the at least one team of the plurality of teams associated with the user profile is moved within the player draft from a first draft position to one or more other draft positions newly assigned to the at least one team of the plurality of teams associated with the user profile within the player draft, the user-selected player is selected in one of the one or more other draft positions assigned to the at least one team of the plurality of teams associated with the user profile.

16. The method of claim 1, further comprising:
determining if the user-selected player is the same as the team-selected player based, at least in part, on a user interaction with a user interface indicating that the user is in agreement with the team-selected player.

17. The method of claim 1, wherein the player draft takes place at a predetermined time, and the user-selected player is selected within a predetermined period following a conclusion of the player draft, or the user-selected player is caused to be the same as the team-selected player.

18. The method of claim 1, further comprising:
tracking one or more user-selected players among one or more users to generate an estimate of a next-selected player, the estimate of the next-selected player being a name of an available player included in the list of available players estimated to be next selected by a team of the plurality of teams, the at least one team of the plurality of teams associated with the user profile, or selected as a user-selected player.

19. The method of claim 18, further comprising:
communicating the estimate of the next-selected player to a user interface.

20. The method of claim 19, wherein
the estimate of a next-selected player is based, at least in part, on an aggregated compilation of a plurality of user-selected players chosen by a plurality of users, the aggregated compilation being used to develop a trend indicating a preferred or predicted player that is to be chosen by the at least one team of the plurality of teams associated with the user profiles of the users of the plurality of users, and
communicating the estimate of the next-selected player to a user interface includes sharing the next-selected player with a social networking service or broadcast media service.

21. The method of claim 1, further comprising:
processing performance statistics associated with the user-selected player and the team-selected player to determine if the at least one team of the plurality of teams associated with the user profile should have taken the user-selected player.

22. The method of claim 21, wherein the performance statistics comprise one or more of games played, games started, win-loss record, player game statistics, captaincy selections, all star selections, all-pro selections, or pro-bowl selections.

23. The method of claim 21, further comprising:
storing one or more user-selected players in the database for a plurality of player drafts;
scoring the one or more user-selected players stored in the database based on accumulated performance statistics; and
assigning an overall score associated with the user profile indicating an overall performance of the user-selected players versus one or more of the at least one team of the plurality of teams associated with the user profile or one or more other users.

24. The method of claim 23, further comprising:
displaying the overall score with a display of the user profile.

25. The method of claim 1, wherein removing a selected player from the list of available players comprises showing the selected player is unavailable.

26. An apparatus comprising:
at least one processor; and
at least one memory including computer program code for one or more programs,
the at least one processor configured to execute an instruction from the at least one memory to cause the apparatus to:
generate a user profile in a roster management system, the user profile being associated with at least one team of a plurality of teams, the plurality of teams together forming a league;
monitor a player draft associated with the league, the player draft being an ordered selection process comprising at least one round, wherein at least some teams of the plurality of teams have an assigned draft position within the at least one round, and the assigned draft position is used by a corresponding team to select a player from a list of available players;
update the list of available players based on a determined selection of a player by one of the teams of the plurality of teams, the updating comprising removing the selected player from the list of available players;
identify a team-selected player, the team-selected player being a player selection made by the at least one team of the plurality of teams associated with the user profile, the team-selected player being selected in the draft position assigned to the at least one team of the plurality of teams associated with the user profile;
store a user-selected player in a database, the user-selected player being selected in the draft position assigned to the at least one team of the plurality of teams associated with the user profile, the user-selected player being selected from the list of available players; and
update the list of available players based on the user-selected player by removing the user-selected player from the list of available players.

27. A non-transitory computer-readable storage medium comprising computer-readable instructions which, when executed by a processor, cause the processor to:
generate a user profile in a roster management system, the user profile being associated with at least one team of a plurality of teams, the plurality of teams together forming a league;
monitor a player draft associated with the league, the player draft being an ordered selection process comprising at least one round, wherein at least some teams of the plurality of teams have an assigned draft position within the at least one round, and the assigned draft position is used by a corresponding team to select a player from a list of available players;
update the list of available players based on a determined selection of a player by one of the teams of the plurality of teams, the updating comprising removing the selected player from the list of available players;
identify a team-selected player, the team-selected player being a player selection made by the at least one team of the plurality of teams associated with the user profile, the team-selected player being selected in the draft position assigned to the at least one team of the plurality of teams associated with the user profile;
store a user-selected player in a database, the user-selected player being selected in the draft position assigned to the at least one team of the plurality of teams associated with the user profile, the user-selected player being selected from the list of available players; and
update the list of available players based on the user-selected player by removing the user-selected player from the list of available players.
